(19) United States
(12) Patent Application Publication
(10) Pub. No.: US 2024/0326707 A1
(43) Pub. Date: Oct. 3, 2024

(54) HITCH APPARATUS AND ATTACHMENTS

(71) Applicant: Youngun's Welding Service LLC, Corpus Christi, TX (US)

(72) Inventor: Cody Taylor, Corpus Christi, TX (US)

(73) Assignee: Youngun's Welding Service LLC, Corpus Christi, TX (US)

(21) Appl. No.: 18/739,224

(22) Filed: Jun. 10, 2024

Related U.S. Application Data
(63) Continuation-in-part of application No. 17/669,326, filed on Feb. 10, 2022, now Pat. No. 12,005,864.

(51) Int. Cl. B60R 9/06; B25H 3/02

(52) U.S. Cl. CPC B60R 9/065; B25H 3/028

(57) ABSTRACT

Attachments for a vehicle hitch receptable are disclosed. A tool box attachment may include a housing having a rear support member adapted for releasable engagement with the hitch receptacle. The tool box attachment may include a slidable tray adapted for slidable movement within an interior compartment of the housing. A tray attachment may include a main central section, a left slidable tray, and a right slidable tray. The left and right slidable trays are adapted for slidable movement relative to the main central section between closed and extended positions. The attachments may be connected to a rotatable hitch apparatus that is mounted to the hitch receptacle. The attachments may be rotated from a first position in which the attachment is positioned beneath the rear of a vehicle, and a second position in which the attachment is positioned behind the vehicle and accessible to a user thereof.

This application is a continuation-in-part of U.S. Non-Provisional patent application Ser. No. 17/669,326, filed Feb. 10, 2022, the contents of which are fully incorporated herein by reference.

### BACKGROUND OF THE INVENTIONS

### 1. Field of the Inventions

The present inventions generally pertain to devices for attachment to vehicles, and more particularly to devices for attachment to a hitch receiver on a vehicle, such as a cargo carrier or a toolbox.

### 2. Description of the Related Art

It is standard for many vehicles, especially on pick-up trucks, to be sold with a trailer hitch mount or receiver at the rear of the vehicle as a standard feature of the vehicle. There are a variety of uses for a trailer hitch mount. The generally known purpose of a trailer hitch mount is to receive a hitch ball adapted for engagement with a trailer hitch tongue on a trailer to be towed behind the vehicle. Another known purpose for a trailer hitch mount is to receive and support various structures, such as cargo carriers that are adapted to engage with a trailer hitch mount. One of the shortcomings of existing structures, such as cargo carriers, that engage with a trailer hitch mount, is that the structure/cargo carrier is generally disconnected from the trailer hitch mount and stored when not in use.

As will become apparent from the description and explanation set forth below, the improved hitch devices and attachments of the present inventions may be rotated out of the way and stored beneath the rear of the vehicle when not in use, as opposed to disconnecting the hitch device and attachments, and storing same separate and apart from the vehicle.

### SUMMARY OF THE INVENTIONS

In one aspect, the present inventions may include a tool box attachment for engagement with a vehicle hitch receptacle comprising: a housing having a rear support member adapted for releasable engagement with the vehicle hitch receptacle; and a slidable tray slidably mounted within an interior compartment of the housing and moveable between an open position and a closed position, the slidable tray including a locking tab adapted for locking engagement with a locking tab on the housing to secure the slidable tray in its closed position. Another feature of this aspect of the present inventions may be that the tool box attachment may further include a support assembly having an upper elongated support member, a lower elongated support member, and a vertical support member, the upper and lower elongated support members being spaced apart from one another, the lower elongated support member having a first socket opening at a first end of the lower elongated support member and a second socket opening at a second end of the lower elongated support member, the lower elongated support member being adapted for rotatable movement relative to the vertical support member and the upper elongated support member, the rear support member being engaged with one of the first and second socket openings, the tool box attachment being moveable from a first position beneath the rear of a vehicle and a second position behind the rear of the vehicle.

In another aspect, the present inventions may include a tray attachment for engagement with a vehicle hitch receptable comprising: a main central portion having a forward support beam, a rear support beam, and a central support beam, the forward and rear support beams being spaced apart from and in generally parallel relationship to each other, the central support beam being attached to the forward and rear support beams in generally perpendicular relationship thereto, the central support beam being releasably engageable with the vehicle hitch receptacle; a left slidable tray having a left support beam, a forward support beam and a rear support beam, the forward support beam on the left slidable tray being slidably engaged with the forward support beam on the main central section, the rear support beam on the left slidable tray being slidably engaged with the rear support beam on the main central section, the left slidable tray being moveable between a closed position and an extended position relative to the main central section; and a right slidable tray having a right support beam, a forward support beam and a rear support beam, the forward support beam on the right slidable tray being slidably engaged with the forward support beam on the main central section, the rear support beam on the right slidable tray being slidably engaged with the rear support beam on the main central section, the right slidable tray being moveable between a closed position and an extended position relative to the main central section. Another feature of this aspect of the present inventions may be that the main central section further includes a metal mesh floor, the left slidable tray includes a metal mesh floor, and the right slidable tray includes a metal mesh floor. Another feature of this aspect of the present inventions may be that the main central section includes a first guide rail on a right end of the rear support beam of the main central section, a second guide rail on a left end of the rear support beam of the main central section, a third guide rail on a right end of the forward support beam of the main central section, and a fourth guide rail on a left end of the forward support beam of the main central section; the left slidable tray includes a rear guide rail attached to the rear support beam of the left slidable tray, and a forward guide rail attached to the forward support beam of the left slidable tray, the rear guide rail being slidably engaged with the second guide rail on the main central section, and the forward guide rail being slidably engaged with the fourth guide rail on the main central section; and the right slidable tray includes a rear guide rail attached to the rear support beam of the right slidable tray, and a forward guide rail attached to the forward support beam of the right slidable tray, the rear guide rail being slidably engaged with the first guide rail on the main central section, and the forward guide rail being slidably engaged with the third guide rail on the main central section. Another feature of this aspect of the present inventions may be that the first and second guide rails are attached to a lower surface of the rear support beam of the main central section, and the third and fourth guide rails are attached to a lower surface of the forward support beam of the main central section. Another feature of this aspect of the present inventions may be that the first, second, third and fourth guide rails are formed from angle iron, the rear and forward guide rails on the left slidable tray are formed from angle iron, and the rear and forward guide rails on the right slidable tray are formed from angle iron. Another feature of this aspect of the present inventions may be that a planar section of the first guide rail is slidably engaged with a planar section of the rear guide rail of the right slidable tray, a planar section of the third guide rail is slidably engaged with a planar section of the forward guide rail on the right slidable tray, a planar section of the second guide rail is slidably engaged with a planar section of the rear guide rail on the left slidable tray, and a planar section of the fourth guide rail is slidably engaged with a planar section of the forward guide rail on the left slidable tray. Another feature of this aspect of the present inventions may be that the first guide rail defines a first guide channel between the first guide rail and the rear support beam, the second guide rail defines a second guide channel between the second guide rail and the rear support beam, the third guide rail defines a third guide channel between the third guide rail and the forward support beam, and the fourth guide rails defines a fourth guide channel between the fourth guide rail and the forward support beam. Another feature of this aspect of the present inventions may be that the rear guide rail on the left slidable tray defines a rear guide channel between the rear support beam on the left slidable tray and the rear guide rail on the left slidable tray, and the forward guide rail on the left slidable tray defines a forward guide channel between the forward support beam on the left slidable tray and the forward guide rail on the left slidable tray; and the rear guide rail on the right slidable tray defines a rear guide channel between the rear support beam on the right slidable tray and the rear guide rail on the right slidable tray, and the forward guide rail on the right slidable tray defines a forward guide channel between the forward support beam on the right slidable tray and the forward guide rail on the right slidable tray. Another feature of this aspect of the present inventions may be that the tray attachment may further include a right support plate connected between a right end of the rear guide rail of the left slidable tray and a right end of the forward guide rail of the left slidable tray; and a left support plate connected between a left end of the rear guide rail of the right slidable tray and a left end of the forward guide rail on the right slidable tray. Another feature of this aspect of the present inventions may be that tray attachment may further include a support assembly having an upper elongated support member, a lower elongated support member, and a vertical support member, the upper and lower elongated support members being spaced apart from one another, the lower elongated support member having a first socket opening at a first end of the lower elongated support member and a second socket opening at a second end of the lower elongated support member, the lower elongated support member being adapted for rotatable movement relative to the vertical support member and the upper elongated support member, the central support beam of the main central section being engaged with one of the first and second socket openings, the tray attachment being moveable from a first position beneath the rear of a vehicle and a second position behind the rear of the vehicle.

In another aspect, the present inventions may include a tray attachment for engagement with a vehicle hitch receptable comprising: a main central portion having a forward support beam, a rear support beam, and a central support beam, the forward and rear support beams being spaced apart from and in generally parallel relationship to each other, the central support beam being attached to the forward and rear support beams in generally perpendicular relationship thereto, the central support beam being releasably engageable with the vehicle hitch receptacle; the main central section further including a first guide rail on a right end of the rear support beam of the main central section, a second guide rail on a left end of the rear support beam of the main central section, a third guide rail on a right end of the forward support beam of the main central section, and a fourth guide rail on a left end of the forward support beam of the main central section; a left slidable tray having a left support beam, a forward support beam and a rear support beam, the forward support beam on the left slidable tray being slidably engaged with the forward support beam on the main central section, the rear support beam on the left slidable tray being slidably engaged with the rear support beam on the main central section, the left slidable tray being moveable between a closed position and an extended position relative to the main central section; the left slidable tray further including a rear guide rail attached to the rear support beam of the left slidable tray, and a forward guide rail attached to the forward support beam of the left slidable tray, the rear guide rail being slidably engaged with the second guide rail on the main central section, and the forward guide rail being slidably engaged with the fourth guide rail on the main central section; a right slidable tray having a right support beam, a forward support beam and a rear support beam, the forward support beam on the right slidable tray being slidably engaged with the forward support beam on the main central section, the rear support beam on the right slidable tray being slidably engaged with the rear support beam on the main central section, the right slidable tray being moveable between a closed position and an extended position relative to the main central section; and the right slidable tray further including a rear guide rail attached to the rear support beam of the right slidable tray, and a forward guide rail attached to the forward support beam of the right slidable tray, the rear guide rail being slidably engaged with the first guide rail on the main central section, and the forward guide rail being slidably engaged with the third guide rail on the main central section. Another feature of this aspect of the present inventions may be that the main central section further includes a metal mesh floor, the left slidable tray includes a metal mesh floor, and the right slidable tray includes a metal mesh floor. Another feature of this aspect of the present inventions may be that the first and second guide rails are attached to a lower surface of the rear support beam of the main central section, and the third and fourth guide rails are attached to a lower surface of the forward support beam of the main central section. Another feature of this aspect of the present inventions may be that the first, second, third and fourth guide rails are formed from angle iron, the rear and forward guide rails on the left slidable tray are formed from angle iron, and the rear and forward guide rails on the right slidable tray are formed from angle iron. Another feature of this aspect of the present inventions may be that a planar section of the first guide rail is slidably engaged with a planar section of the rear guide rail of the right slidable tray, a planar section of the third guide rail is slidably engaged with a planar section of the forward guide rail on the right slidable tray, a planar section of the second guide rail is slidably engaged with a planar section of the rear guide rail on the left slidable tray, and a planar section of the fourth guide rail is slidably engaged with a planar section of the forward guide rail on the left slidable tray. Another feature of this aspect of the present inventions may be that the first guide rail defines a first guide channel between the first guide rail and the rear support beam, the second guide rail defines a second guide channel between the second guide rail and the rear support beam, the third guide rail defines a third guide channel between the third guide rail and the forward support beam, and the fourth guide rails defines a fourth guide channel between the fourth guide rail and the forward support beam. Another feature of this aspect of the present inventions may be that the rear guide rail on the left slidable tray defines a rear guide channel between the rear support beam on the left slidable tray and the rear guide rail on the left slidable tray, and the forward guide rail on the left slidable tray defines a forward guide channel between the forward support beam on the left slidable tray and the forward guide rail on the left slidable tray; and the rear guide rail on the right slidable tray defines a rear guide channel between the rear support beam on the right slidable tray and the rear guide rail on the right slidable tray, and the forward guide rail on the right slidable tray defines a forward guide channel between the forward support beam on the right slidable tray and the forward guide rail on the right slidable tray. Another feature of this aspect of the present inventions may be that the tray attachment may further include a right support plate connected between a right end of the rear guide rail of the left slidable tray and a right end of the forward guide rail of the left slidable tray; and a left support plate connected between a left end of the rear guide rail of the right slidable tray and a left end of the forward guide rail on the right slidable tray.

Other features, aspects and advantages of the present inventions will become apparent from the following discussion and detailed description.

### BRIEF DESCRIPTION OF THE DRAWINGS

FIG. 1 is a perspective view of a specific embodiment of a trailer hitch apparatus constructed in accordance with one aspect of the present inventions.

FIG. 1A is a perspective view of a portion of the trailer hitch apparatus shown in FIG. 1 taken from the direction as indicated in FIG. 1.

FIG. 1B is cross sectional view taken along line 1B-1B in FIG. 1.

FIG. 1C is an exploded view of a portion of the trailer hitch apparatus shown in FIG. 1.

FIG. 2 is a side view of the trailer hitch apparatus as shown in FIG. 1.

FIG. 3 is a top view of the trailer hitch apparatus as shown in FIG. 1 and in the process of being rotated from a first position to a second position.

FIG. 4 is a top view similar to FIG. 3 but showing the trailer hitch apparatus from FIG. 1 in its second position in dashed lines with a cargo rack positioned beneath a rear end of a vehicle to which the apparatus is attached.

FIG. 5 is a side view of the trailer hitch apparatus as shown in FIG. 1 but not connected to a vehicle.

FIG. 6 is a side view in partial cross section of a portion of the hitch apparatus as shown in FIG. 1.

FIG. 6A is a detailed view of a portion of the hitch apparatus shown in FIG. 6.

FIG. 6B is a detailed view of a portion of the hitch apparatus shown in FIG. 6.

FIG. 7 is a perspective view showing a hitch apparatus secured to a hitch on the rear bumper of a vehicle with a tool box attachment attached to the hitch apparatus and extending away from the rear of the vehicle, and a tray attachment attached to an opposed end of the hitch apparatus and positioned beneath the rear of the vehicle.

FIG. 8 is a perspective view similar to FIG. 7, but with the tool box attachment positioned beneath the rear of the vehicle and the tray attachment extending away from the rear of the vehicle.

FIG. 9 is a side view of the configuration shown in FIG. 7.

FIG. 10 is a side view of the configuration shown in FIG. 8.

FIG. 11 is a perspective view of a specific embodiment of a tray attachment mounted to a trailer hitch.

FIG. 12 is a top view of the configuration shown in FIGS. 8 and 10, with the tray attachment extending away from the rear of the vehicle, and the tool box attachment shown in dashed lines positioned underneath the rear of the vehicle.

FIG. 13A is a top view of a tray attachment detached from the trailer hitch and in a first or closed position, similar to FIG. 11.

FIG. 13B is a top view of the tray attachment detached from the trailer hitch and in a second or open position, with left and right slidable trays in extended positions, similar to what is shown in FIGS. 22 and 23, discussed below.

FIG. 14 is a perspective view showing a lower side of a main central section of the tray attachment.

FIG. 15 is a top perspective view of a specific embodiment of a left slidable tray that may form part of the tray attachment, and is shown attached to a main central section of the tray attachment and in an extended position.

FIG. 16 a bottom perspective view of the left slidable tray shown in FIG. 15, and shown separated from the main central section.

FIG. 17 is another perspective view showing the lower side of the left slidable tray shown in FIGS. 15 and 16.

FIG. 18 is an end view of the left slidable tray shown in FIGS. 15-17.

FIG. 19 is an end view showing a portion of the left slidable tray shown in FIGS. 15-18.

FIG. 20 is a perspective view showing the left slidable tray, the main central section, and the right slidable tray positioned adjacent to but separated from each other.

FIG. 21 is a top perspective view of a specific embodiment of the right slidable tray that may form part of the tray attachment, and is shown attached to the main central section of the tray attachment and in an extended position.

FIG. 22 is a top view showing the tray attachment with the left and right slidable trays attached to the main central section of the tray attachment and in their respective extended positions.

FIG. 23 is an end view of the tray attachment when attached to the rear of a vehicle and with the left and right slidable trays in their respective extended positions.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

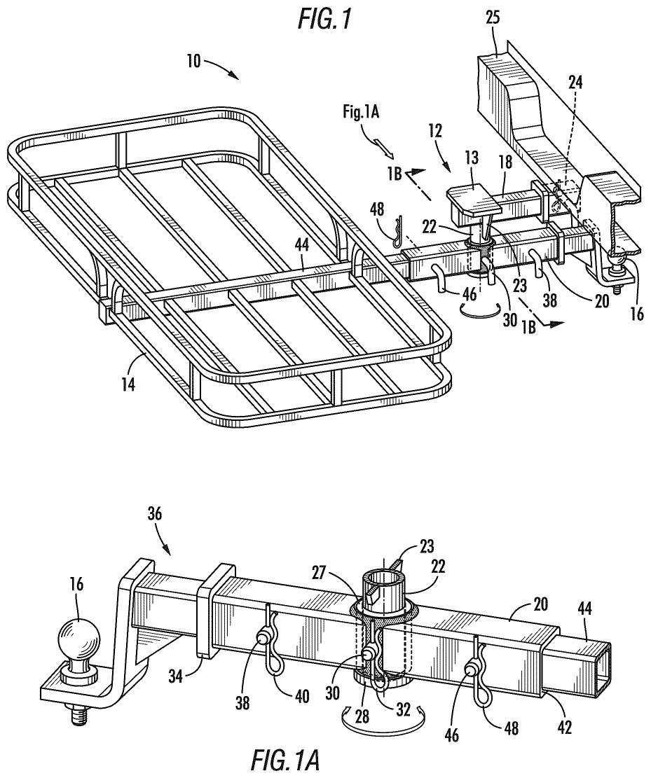

Referring to the drawings in detail, wherein like numerals denote identical elements throughout the several views, and referring initially to FIG. 1, there is shown a specific embodiment of a hitch apparatus 10 including a support assembly 12 releasably connected to a cargo tray 14 on one end and a ball hitch 16 on an opposite end. The cargo tray 14 may include an elongated cargo tray support member 44 (such as made from square metal tubing) adapted for releasable engagement with the support assembly 12, as more fully discussed below. The cargo tray 14 may also include a slide out tray for storing various items, such as tools. The support assembly 12 may include an upper elongated support member 18, a lower elongated support member 20, and a vertical support member 22. In a specific embodiment, the support assembly 12 may include a step plate 13 attached to an upper surface of the upper elongated support member 18. In a specific embodiment, the upper elongated support member 18 may be a section of square steel tubing sized for slidable engagement within a standard hitch receiver 24 of the type that is standard equipment on many new vehicles, especially including pick-up trucks. The hitch receiver 24 may be mounted below a rear bumper 25. In a specific embodiment, the lower elongated support member 20 may also be constructed of square steel tubing, but of a larger size that may receive a section of square tubing that is the same size as the upper elongated support member 18. In a specific embodiment, the upper elongated support member 18 and the lower elongated support member 20 may be disposed in generally parallel relationship to one another.

The vertical support member 22 may be secured, such as by welding, to the upper elongated support member 18 and extend downwardly away therefrom in generally perpendicular relationship to the upper elongated support member 18. One or more gussets 23 may be provided for additional structure support for the vertical support member 22. In a specific embodiment, the vertical support member 22 may be constructed from a section of round steel tubing, such as a section of 1.5-inch steel pipe, for example. The lower elongated support member 20 may include a vertical bore 26. In a specific embodiment, the vertical bore 26 may be defined by a section of round steel tubing 27, such as a section of two-inch steel pipe. The lower elongated support member 20 may also include a transverse bore 21, such as through the center of the vertical bore 26. The vertical support member 22 may be disposed for rotatable movement through the vertical bore 26. A retaining member 28, such as a retaining ring or a flat plate, may be secured to a lower end of the vertical support member 22 to support the lower elongated support member 20 and provide a bearing surface on which the lower elongated support member 20 may rotate, such as indicated by the arrows in FIG. 1A. A lower end of the vertical support member 22 is provided with a transverse bore 29 adapted for alignment with the transverse bore 21 through the lower elongated support member 20. A first pin 30 may be removably inserted through the aligned transverse bores 21 and 29 to prevent or permit rotation of the lower elongated support member 20 relative to the vertical support member 22. The first pin 30 may be secured with a first cotter pin 32.

With reference to FIG. 1A, a first end 34 of the lower elongated support member 20 may removably receive a ball hitch assembly 36 including the ball hitch 16. The ball hitch assembly 36 may be secured in place with a second pin 38 and a second cotter pin 40 in a known manner. A second end 42 of the lower elongated support member 20 may removably receive the cargo tray support 44. The cargo tray support 44 may be a section of square tubing of the same size as the upper elongated support member 18. The cargo tray support 44 may be secured in place with a third pin 46 and a third cotter pin 48 in the same manner as with the other pins 30 and 38.

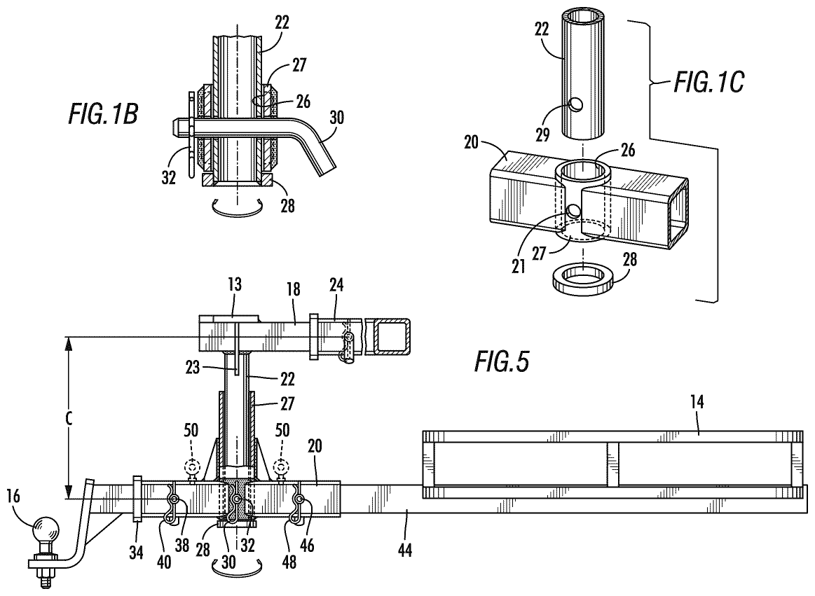

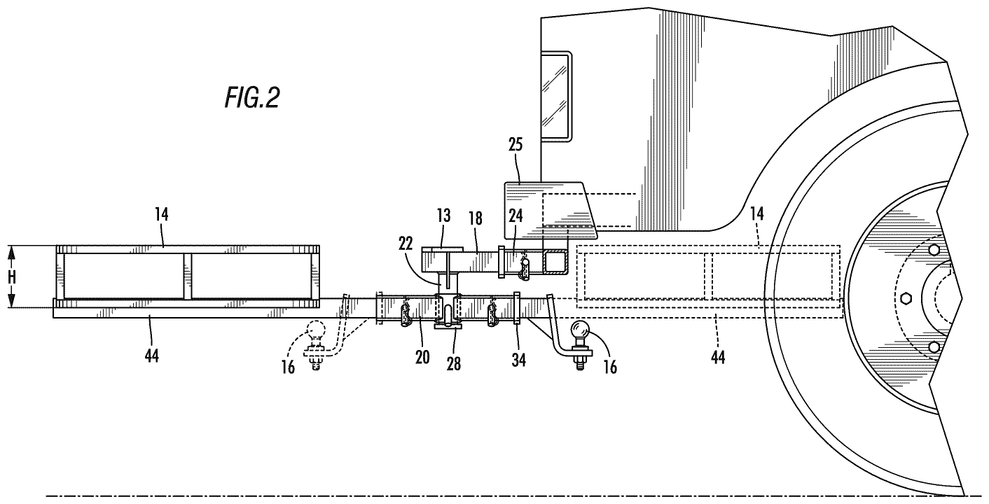

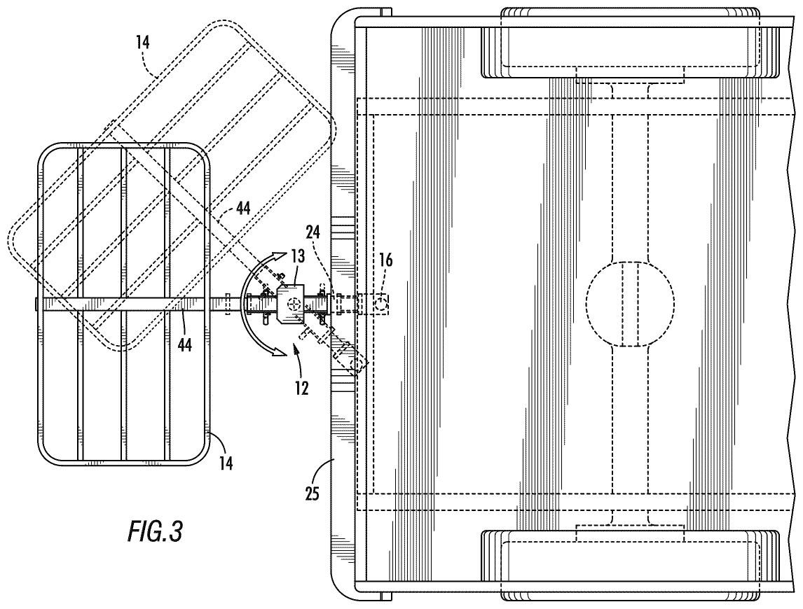

With reference to FIG. 4, the cargo tray 14 is shown in a first or rearward position, in which it can be used to carry various items of cargo. When the cargo tray 14 is no longer needed for use, it can be rotated out of sight and beneath the vehicle to a second or forward position, as shown in dashed lines in FIGS. 2 and 4. To rotate the cargo tray 14 to its second position, the first pin 30 is removed to allow rotational movement of the lower elongated support member 20 relative to the upper elongated support member 18. With reference to FIG. 3, once the first pin 30 is removed, the cargo tray 14 can then be rotated, such as to move the cargo tray 14 from its first position towards its second position. The cargo tray 14 is provided with dimensions that will allow for clearance from striking any part of the vehicle when rotating it between its first and second positions. In a specific embodiment, the cargo tray 14 may be approximately forty inches long and twenty inches wide. In a specific embodiment, with reference to FIG. 2, the height H of the cargo tray 14 may be approximately two to four inches.

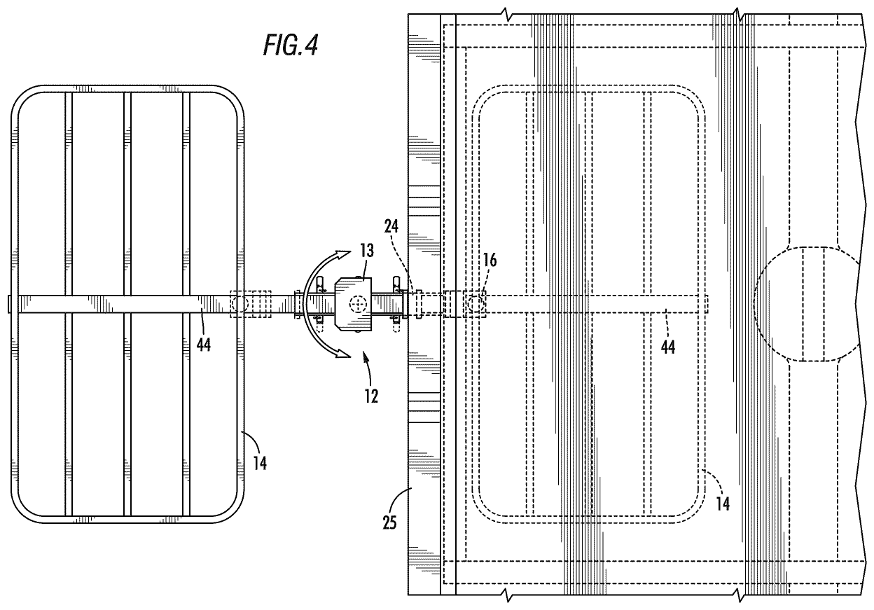

Referring now to FIG. 5, in another specific embodiment, the pipe 27 may extend upwardly above the lower elongated support member 20 to provide additional structural support for the vertical support member 22. In a specific embodiment, a transverse adjusting pin (not shown) may be provided for removably engagement with transverse bores through the vertical support member 22 and the pipe 27 between the lower elongated support member 20 and the upper elongated support member 18 to allow for adjustment of a distance C between the upper and lower elongated support members 18 and 20. This may be desired depending on the particular configuration and design of a vehicle to which a device of the present inventions is engaged. In a specific embodiment, the distance C may be in the range of four to five inches. In another specific embodiment, one or more loop members 50 may be provided on top of the lower elongated support member 22 for purposes of lifting or lowering the lower elongated support member 22 relative to the upper elongated support member 18 if the distance between them is being adjusted.

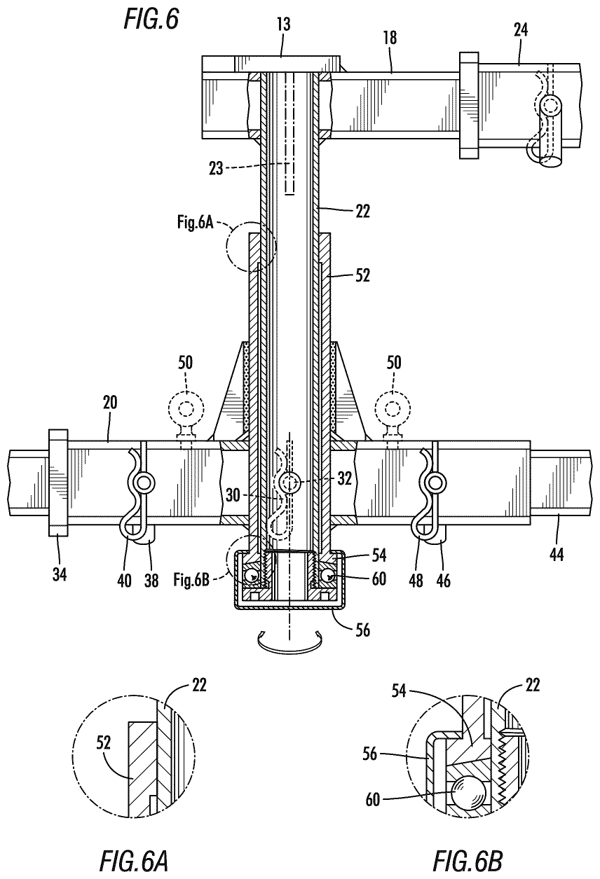

Referring now to FIGS. 6, 6A, and 6B, in another specific embodiment, instead of the pipe 27 as shown in FIG. 1C, the apparatus may be provided with a vertical sleeve 52 that may extend above and below the lower elongated support member 20, and secured thereto, such as by welding. A lower end 54 of the vertical sleeve 52 may be connected to a housing 56. A lower end of the vertical support member 22 may extend downwardly within the vertical sleeve 52 and then below the lower end 54 of the vertical sleeve 52. A retaining nut or T-member 58 may be threadably attached or welded to the lower end of the vertical support member 22 with a bearing 60 disposed and retained between the nut/T-member 58 and the lower end 54 of the vertical sleeve 52. In a specific embodiment, the bearing 60 may be a tapered thrust bearing, such as ball or roller bearing. The bearing 60 may aid in alignment and ease of use of the apparatus of the present inventions. The bearing 60 may be permanently fixed to a base plate, such as the nut/T-member 58, and may allow the outer vertical pipe sleeve 52 to rest on top of the bearing 60 and permanently fixed to the outer pipe sleeve 52. In this manner, friction upon rotation of the lower elongated support member 20 relative to the upper elongated support member 18 may be reduced in comparison to the embodiments described above. The use of a bearing 60 in this embodiment may also have the added benefit of reducing slop or wiggle between the vertical support member 22 and the vertical outer sleeve member 52. In another specific embodiment, another bearing 60 may be attached above the lower elongated support member 20 to an upper end of the outer sleeve member 52 and the vertical support member 22, such as around the section corresponding to FIG. 6A. In a specific embodiment, tongue weight or cargo weight when in use may be supported by a ⅝-inch tow pin of the type already in the market.

As discussed above, cargo racks adapted for releasable engagement with a standard hitch receiver 24 is known. Those cargo racks, however, are stored away from the vehicle, such as in a garage or shed, when not in use. Then, when the cargo rack is needed, it must be retrieved from storage and engaged with the hitch receiver 24. With the present inventions, however, the cargo tray 14 can always be on board the vehicle. But the cargo tray 14 is not always in its rearward position where it can be used for hauling items such as a cooler. Instead, with the present inventions, when the cargo tray 14 is not needed for use in its rearward position, it is rotated to its forward position underneath the vehicle, where it is generally out of sight and not readily visible. When in this forward position, the hitch ball 16 is in a rearward position where it is available for use to engage with a trailer, for example. When need for the cargo tray 14 arises, it can quickly be rotated to its rearward position for use, as shown for example in FIG. 4. The hitch systems of the present inventions may be sold as an aftermarket product or provided as an option or even a standard feature with new vehicles.

It is further noted that the present inventions are not limited to the use of cargo trays, such as cargo tray 14, with the present inventions. For example, instead of a cargo tray 14, other components such as a step or other receiver attachment may be used as part of or in combination with the present inventions. By spinning the cargo rack, step, or other attachment under the vehicle while maintaining the opposite facing receiver, such as for the ball hitch 16, constant availability and ready instant access of many attachments and options such as to pull a trailer is always available without retrieving attachments from storage. Also, the ability to rotate an attachment such as the cargo tray 14 out of sight beneath the vehicle eliminates back-up camera and bumper sensor alerts. This also results in a better appearance and cleaner look around the vehicle when cargo capacity is not needed.

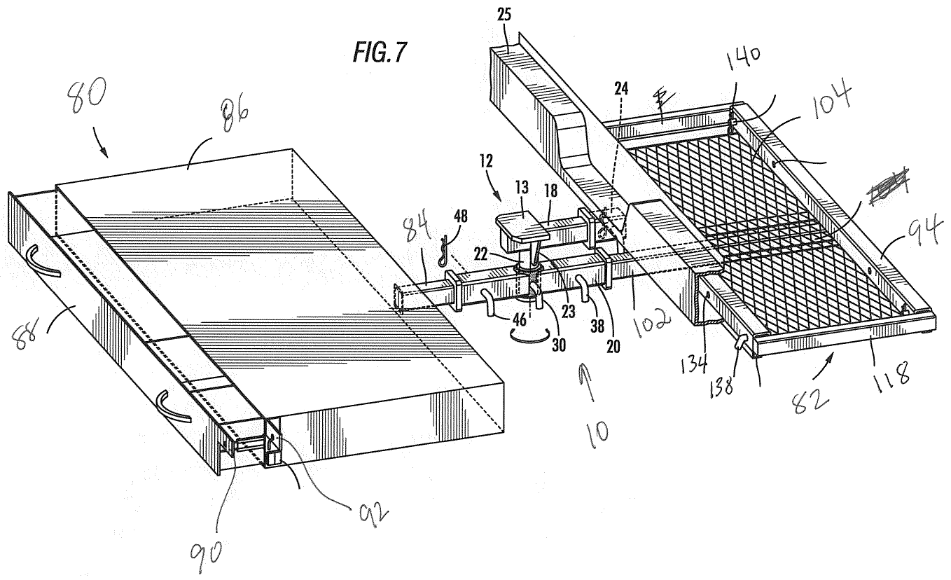

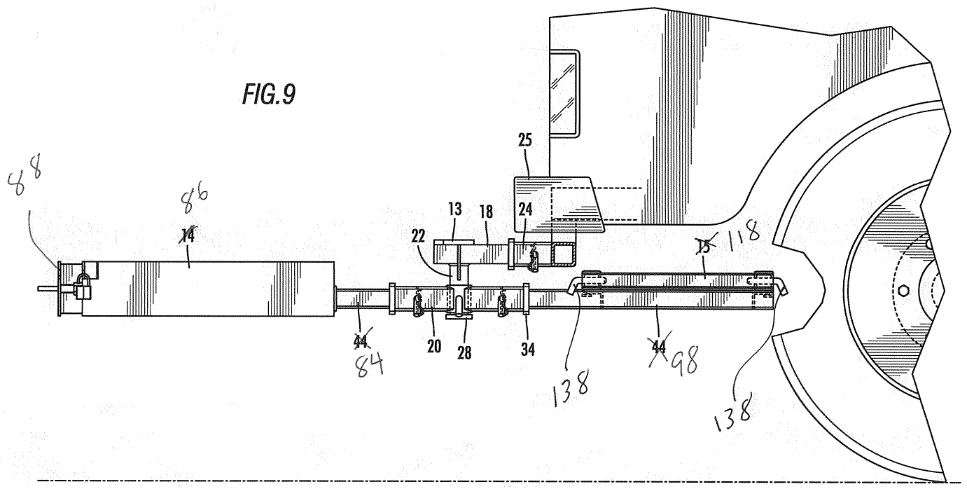

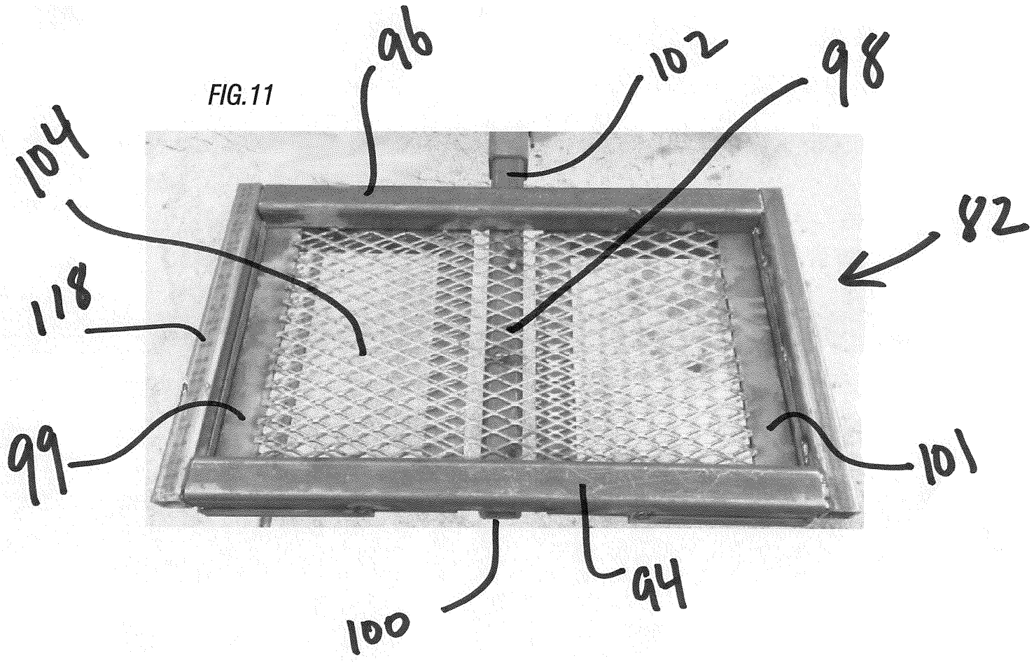

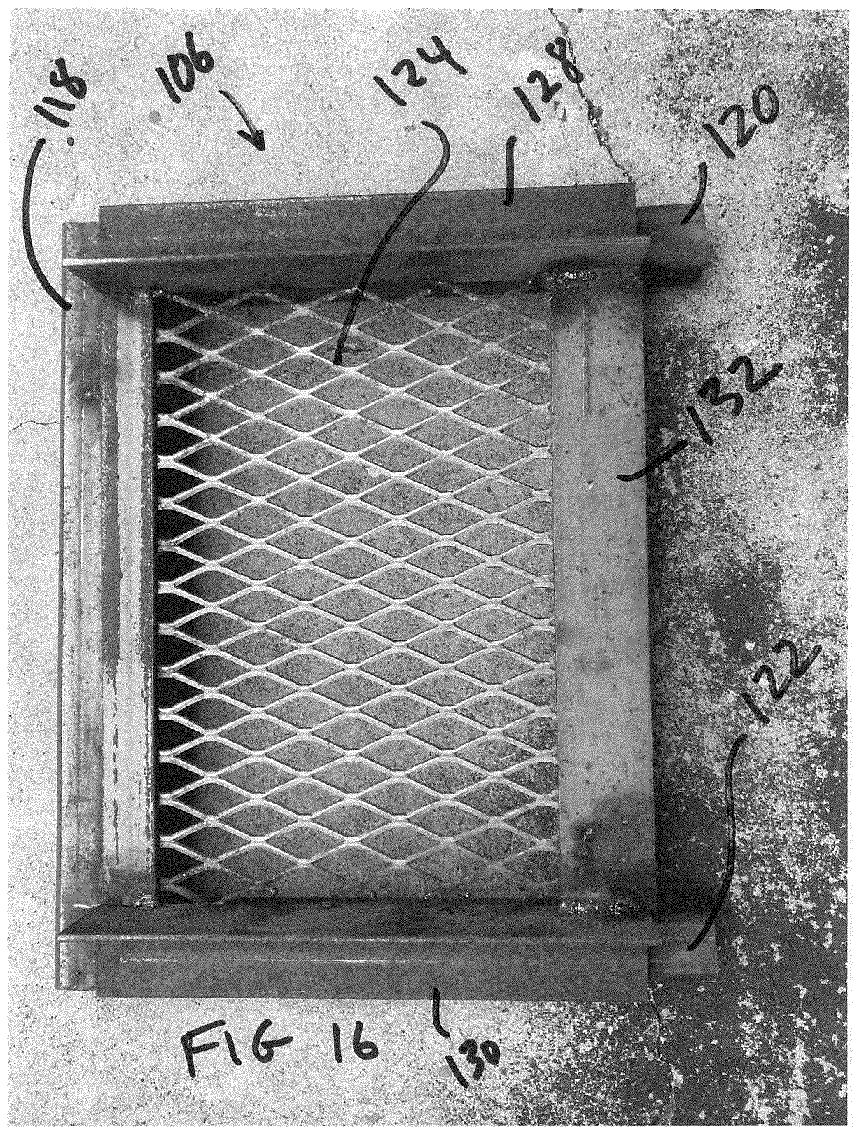

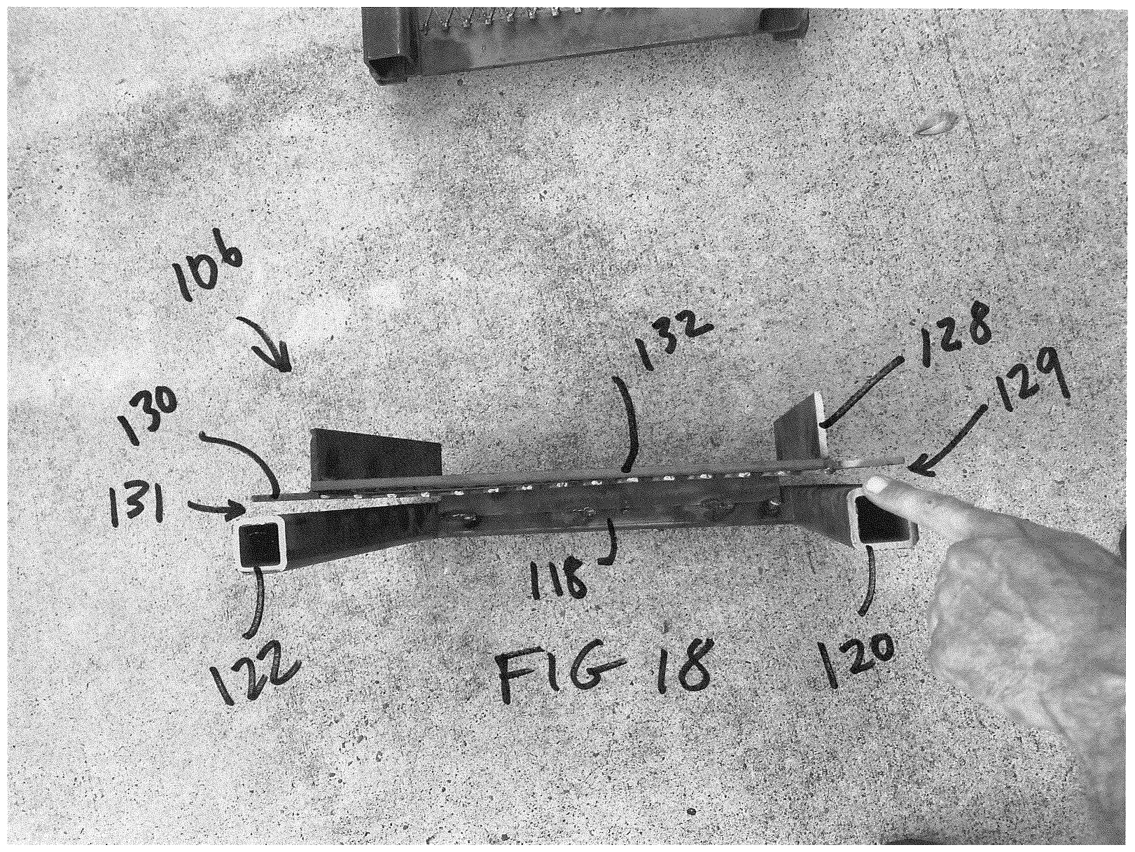

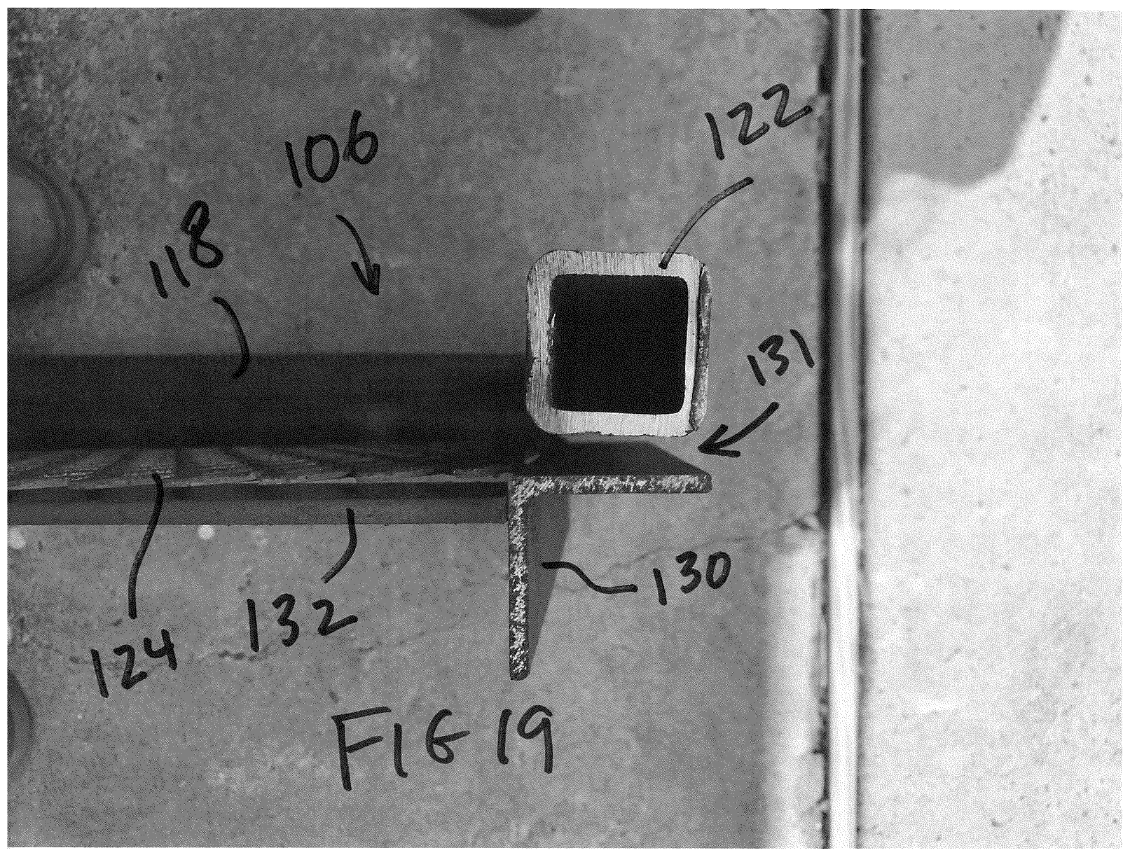

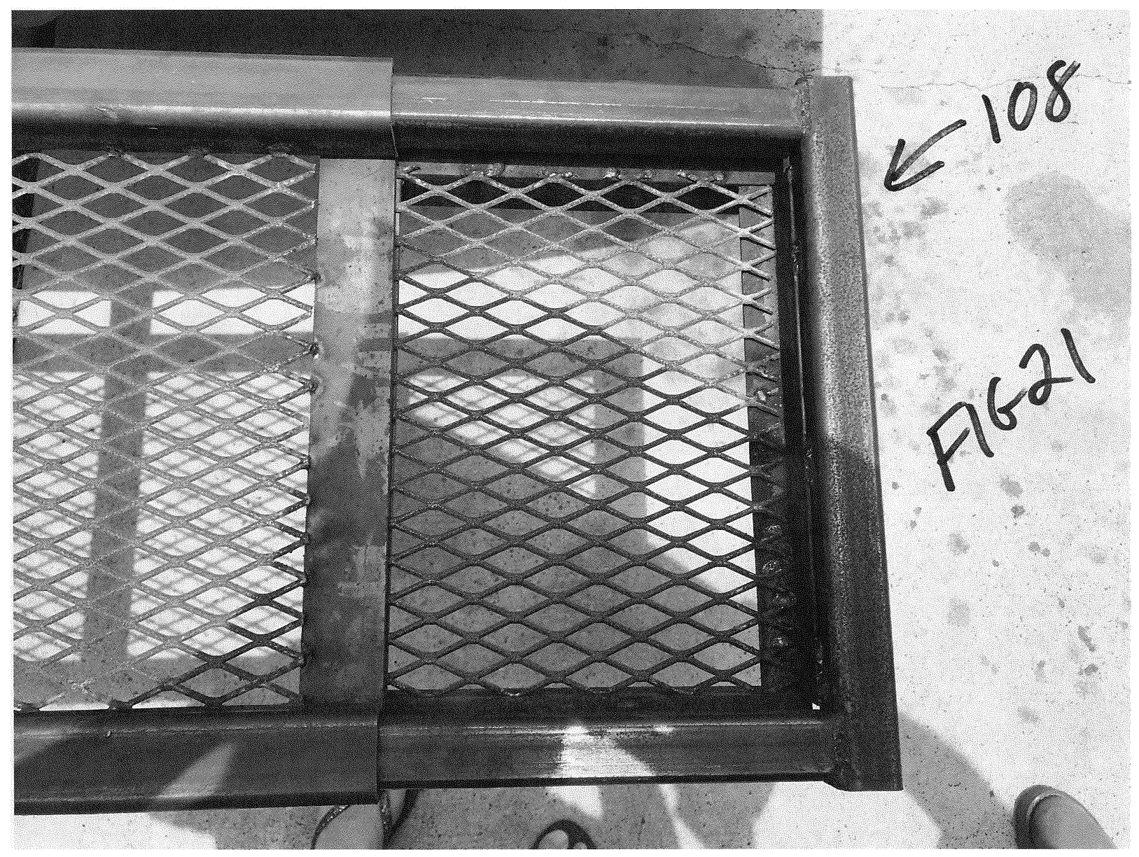

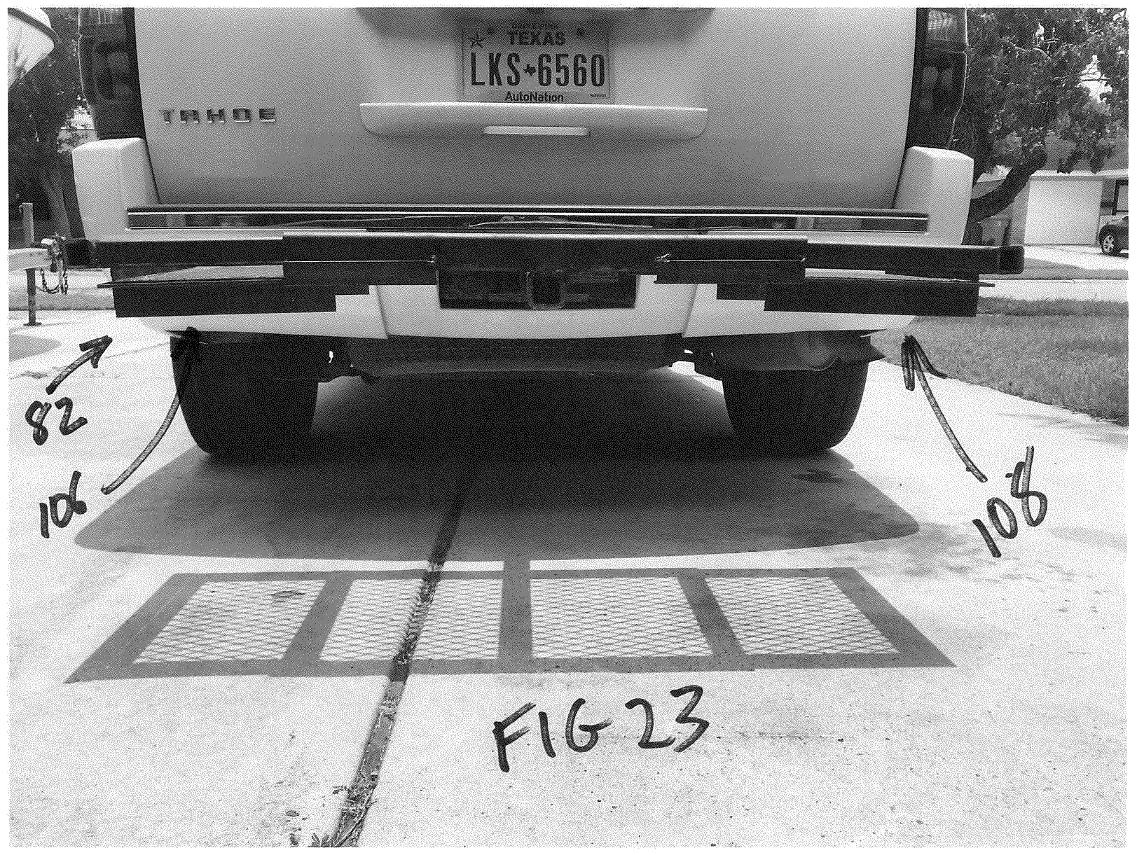

Referring now to FIGS. 7-23, various specific embodiments of attachments that may be used in combination with the hitch apparatus 10 are shown. Referring now to FIG. 7, a specific embodiment of a tool box attachment 80 is shown engaged with the hitch apparatus 10 and extending away from the rear bumper 25 of a vehicle. FIG. 7 also shows a specific embodiment of a tray attachment 82 also engaged with the hitch apparatus 10 and positioned beneath the rear of a vehicle.

The tool box attachment 80 may include a rear support member 84 attached to a rear side of a housing 86. The rear support member 84 is adapted for releasable engagement with the lower elongated support member 20 on the support assembly 12 using the third pin 46 and third cotter pin 48. The housing 86 may be a rectangular enclosure having a rectangular opening on a front side of the housing 86. The tool box attachment 80 may include a slidable tray 88 slidably mounted to the housing 86 and adapted for insertion into an interior of the housing 86 through the opening in the front of the housing 86. A front panel of the slidable tray 88 may include a tab 90 adapted for locking engagement with a tab 92 on the housing 86 to lock the tray in a closed position during transit. The front panel of the slidable tray 88 may also include one or more handles for use in moving the slidable tray 88 in and out of the housing 86.

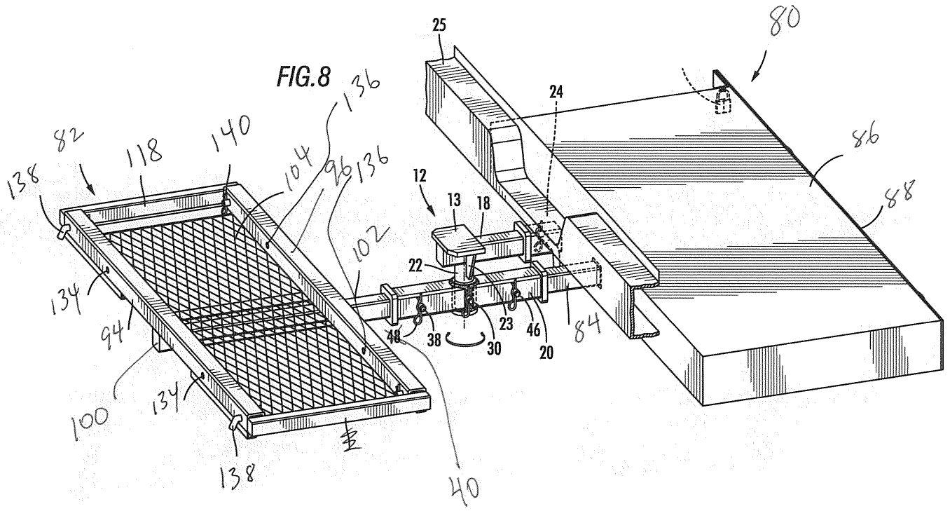

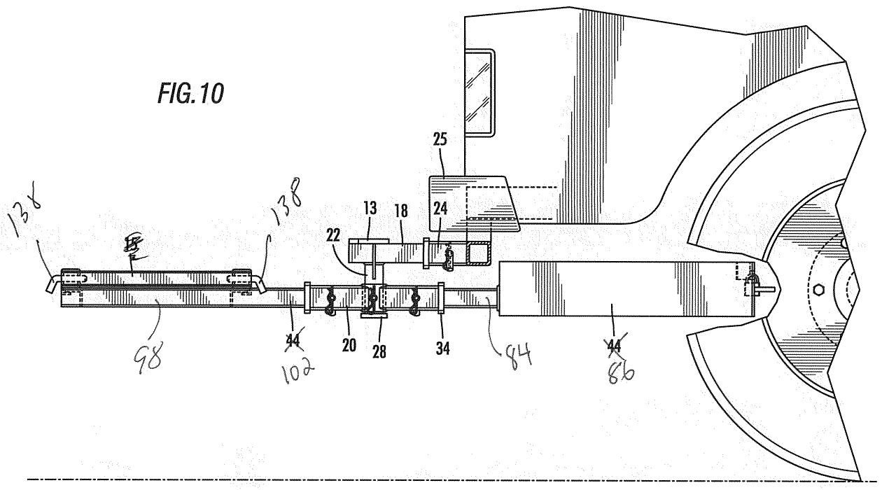

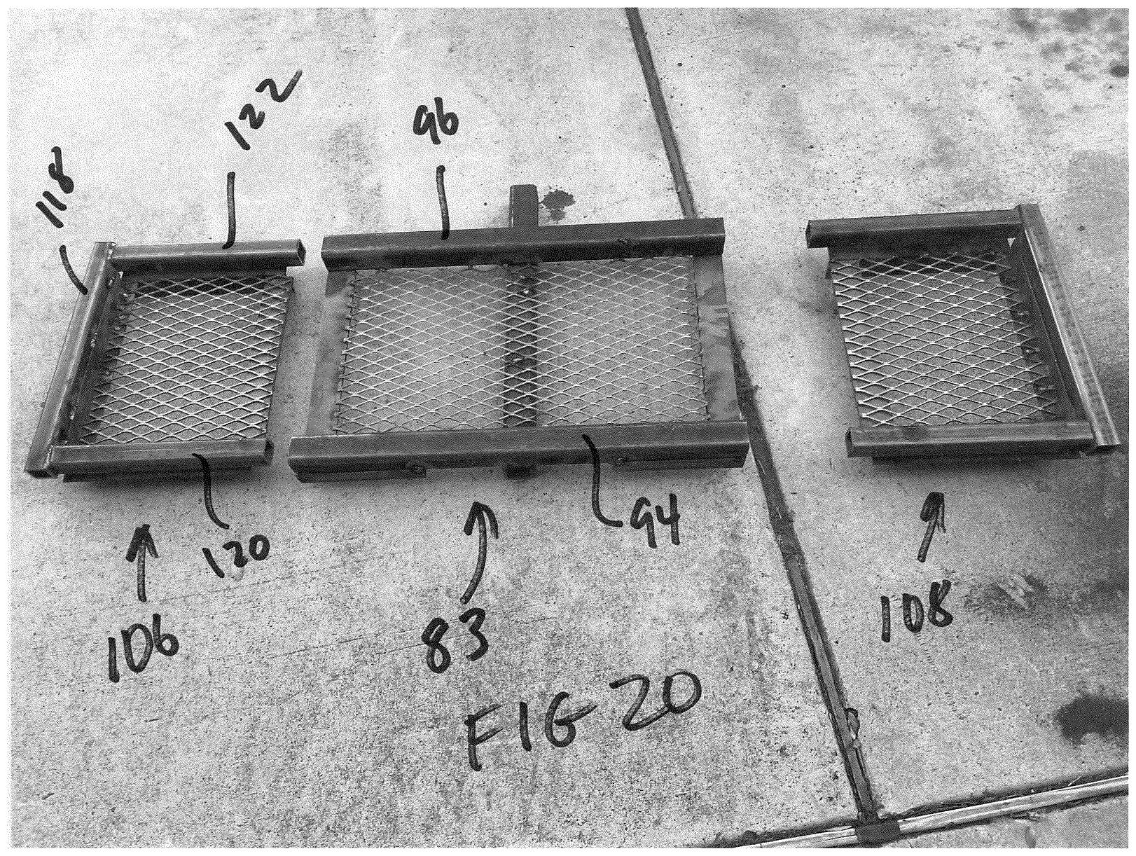

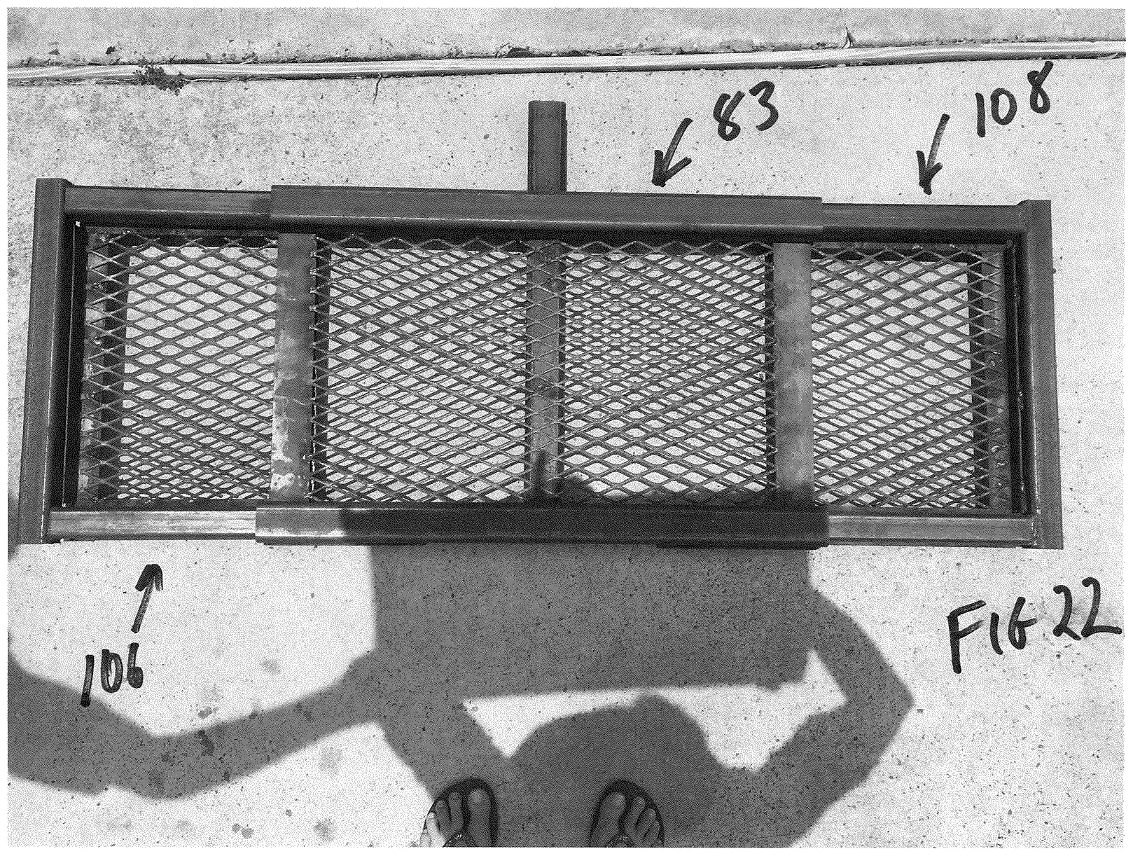

Referring now to FIG. 8, the tray attachment 82 is shown now rotated from underneath the rear of the vehicle and is now extending behind the vehicle and away from the rear bumper 25. The tray attachment 82 may include a main central section 83 (see FIGS. 20 and 22) having a frame formed by a forward support beam 94, a rear support beam 96, and a central support beam 98 (see, e.g., FIGS. 10, 11 and 14), each of which may be formed from square tubing. The forward support beam 94 and the rear support beam 96 may be spaced apart and in generally parallel relationship to each other. The central support beam 98 may be attached to lower surfaces of the forward support beam 94 and the rear support beam 96, and positioned in generally perpendicular relationship thereto. A first end 100 of the central support beam 98 may be positioned adjacent a forward surface of the forward support beam 94. A second end 102 of the central support beam 98 may extend rearwardly away from the rear support beam 96, and adapted for releasable engagement with the lower elongated support member 20 on the support assembly 12 of the hitch apparatus 10 using the second pin 38 and second cotter pin 40. The main central section 83 of the tray attachment 82 may also include a metal mesh floor 104 that may be attached to lower surfaces of the forward support beam 94 and the rear support beam 96, and may rest on and/or also be attached to an upper surface of the central support beam 98.

The main central section 83 of the tray attachment 82 may also include a left support plate 99 and a right support plate 101. The left support plate 99 may be attached adjacent to left ends of the forward support beam 94 and the rear support beam 96, and positioned in generally perpendicular relationship thereto. A left side of the metal mesh floor 104 may be attached to the left support plate 99. The right support plate 101 may be attached adjacent to right ends of the forward support beam 94 and the rear support beam 96, and positioned in generally perpendicular relationship thereto. A right side of the metal mesh floor 104 may be attached to the right support plate 101.

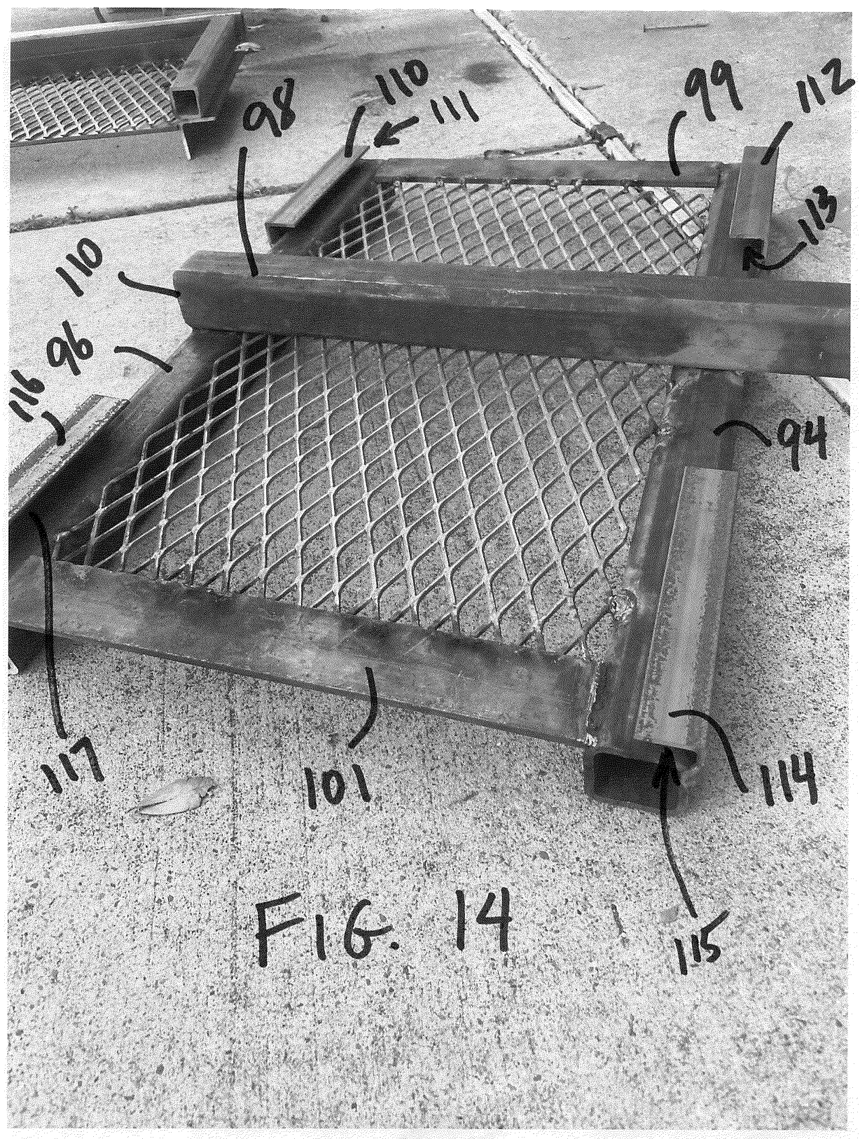

Referring now to FIG. 14, which shows a lower side of the tray attachment 82, it can be seen that the main central section 83 may include guide rails 110, 112, 114, and 116 that may be attached to lower surfaces of opposed ends of the forward support beam 94 and the rear support beam 96 (i.e., generally on the underside of the main central section 83 at each corner thereof). The guide rails 110-116 may be formed from sections of angle iron. The guide rails 110-116 may be attached in generally parallel relationship to the corresponding forward and lower support beams 94 and 96 and include planar plates spaced apart therefrom so as to form slide channels 111, 113, 115, and 117 between the planar plates and the corresponding forward and lower support beams 94 and 96. The purpose of the guide rails 110-116 will become apparent from the further descriptions below.

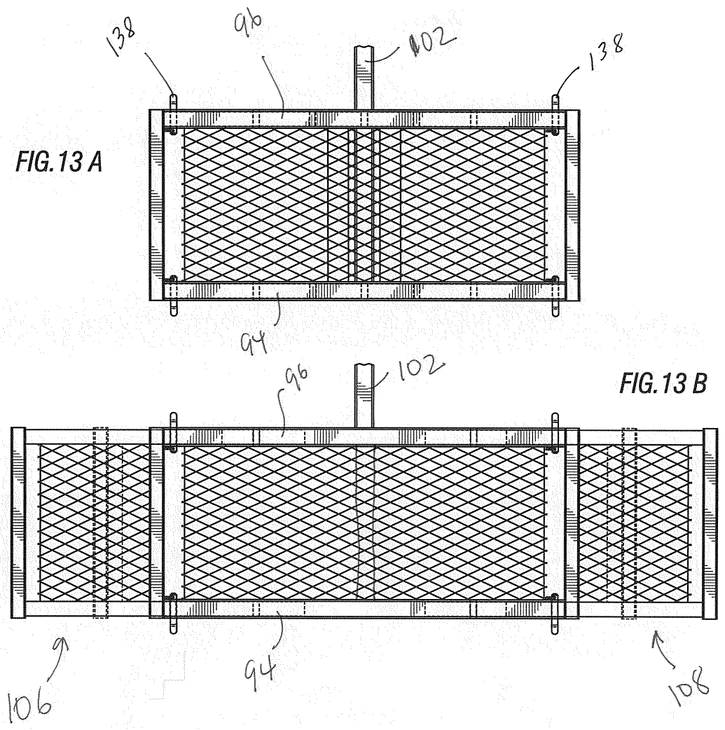

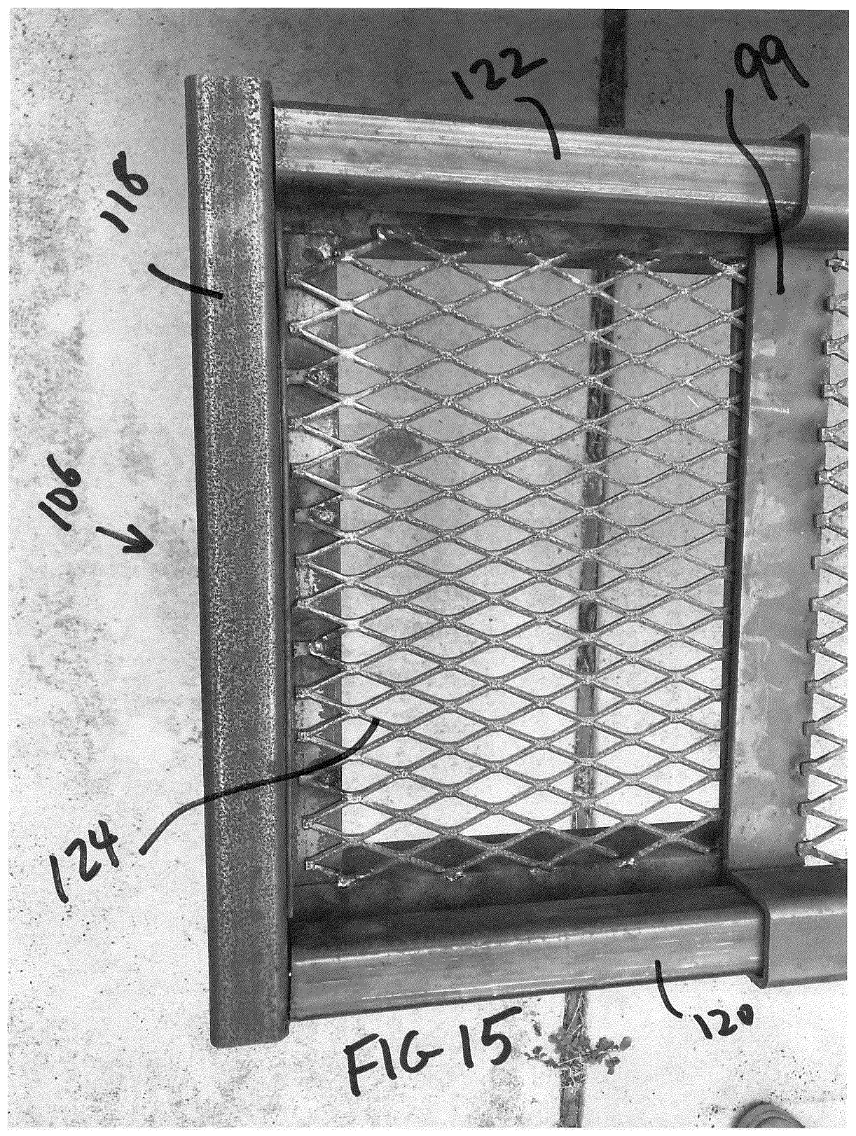

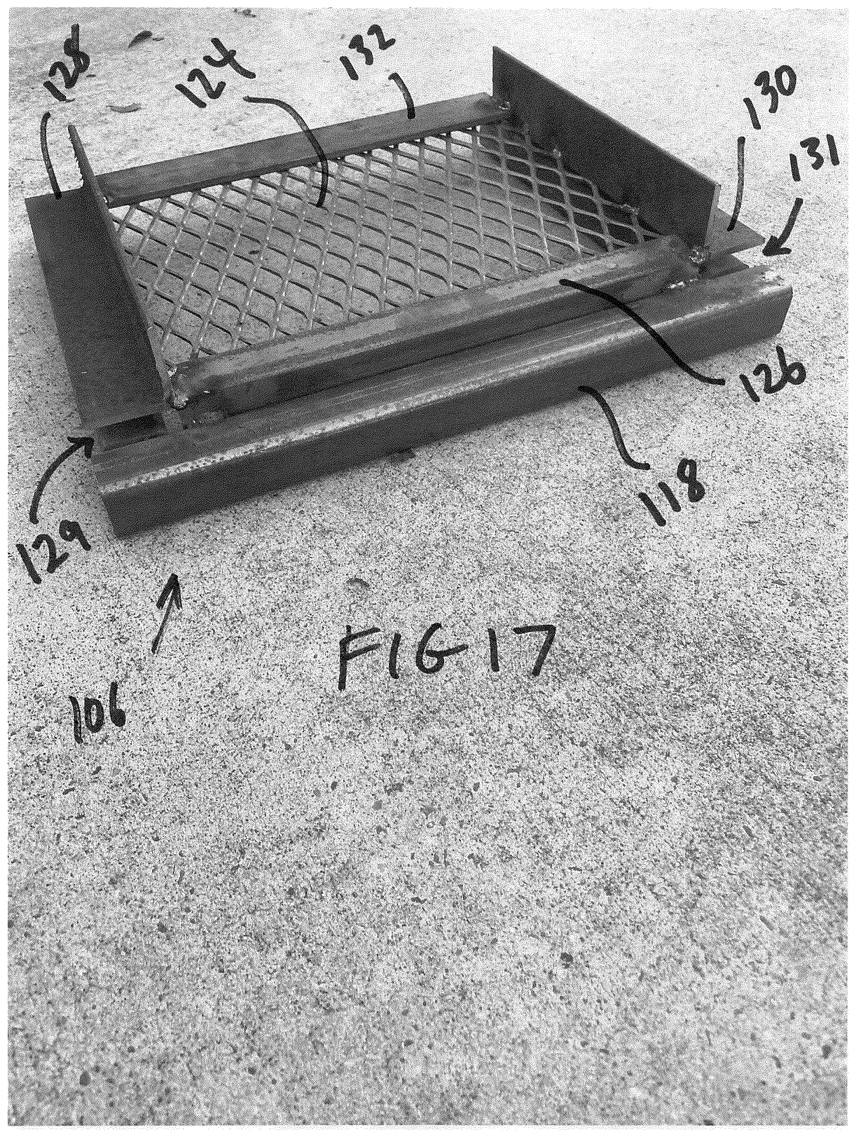

In a specific embodiment, as can be seen in FIGS. 7, 8 and 11, but best seen in FIG. 13B, the tray attachment 82 may include a left slidable tray 106 and a right slidable tray 108. Referring now to FIGS. 15-19, it can be seen that the left slidable tray 106 may include a left support beam 118, a forward support beam 120, a rear support beam 122, and a metal mesh floor 124. As best seen in FIG. 17, an inner support beam 126 may be secured to the left support beam 118 in parallel relationship thereto. A lower surface of the inner support beam 126 may be positioned below or spaced apart from a lower surface of the left support beam 118. A left side of a forward guide rail 128 may be secured to a forward end of the inner support beam 126. The forward guide rail 128 may be spaced apart from and in generally parallel alignment with the forward support beam 120 so as to form a space or channel 129 between a lower surface of the forward support beam 120 and an upper planar surface of the forward guide rail 128, the purpose of which will be understood from the further description below. A left side of a rear guide rail 130 may be secured to a rear end of the inner support beam 126. The rear guide rail 130 may be spaced apart from and in generally parallel alignment with the rear support beam 122 so as to form a space or channel 131 between a lower planar surface of the rear support beam 122 and an upper surface of the rear guide rail 130, the purpose of which will be understood from the further description below. The forward and rear guide rails 128 and 130 may be formed from angle iron. Right sides of the forward and rear guide rails 128 and 130 may be connected to a right support plate 132, which may be connected in generally perpendicular relationship to the forward and rear guide rails 128 and 130, and in generally parallel relationship to the left support beam 118 and the inner support beam 126. The metal mesh floor 124 may be secured to the inner support beam 126, the forward guide rail 126, the rear guide rail 130, and the right support plate 132.

Referring now to FIG. 20, the left slidable tray 106, the main central tray 83, and the right slidable tray 108 are shown separated from each other. The left and right slidable trays 106 and 108 are positioned and ready to be inserted into installed engagement with the main central section 83. The rear support beam 122 on the left slidable tray 106 is adapted to be inserted into the rear support beam 96 on the main central section 83. To accommodate this, the rear support beam 122 on the left slidable tray 106 may be made from 1.5 inch square tubing, and the rear support beam 96 on the main central section 83 may be made from 2 inch tubing. The same sizes may be used for the forward support beam 120 on the left slidable tray 106 and the forward support beam 94 on the main central section 83. As the forward and rear support beams 120 and 122 on the left slidable tray 106 are inserted into the forward and rear support beams 94 and 96 on the main central section 83, respectively, the forward guide rail 128 on the left slidable tray 106 will move into sliding engagement with the guide rail 110 on the main central section 83, and the rear guide rail 130 on the left slidable tray 106 will move into sliding engagement with the guide rail 112 on the main central section 83. This is facilitated by the spacing and guide channels as discussed above.

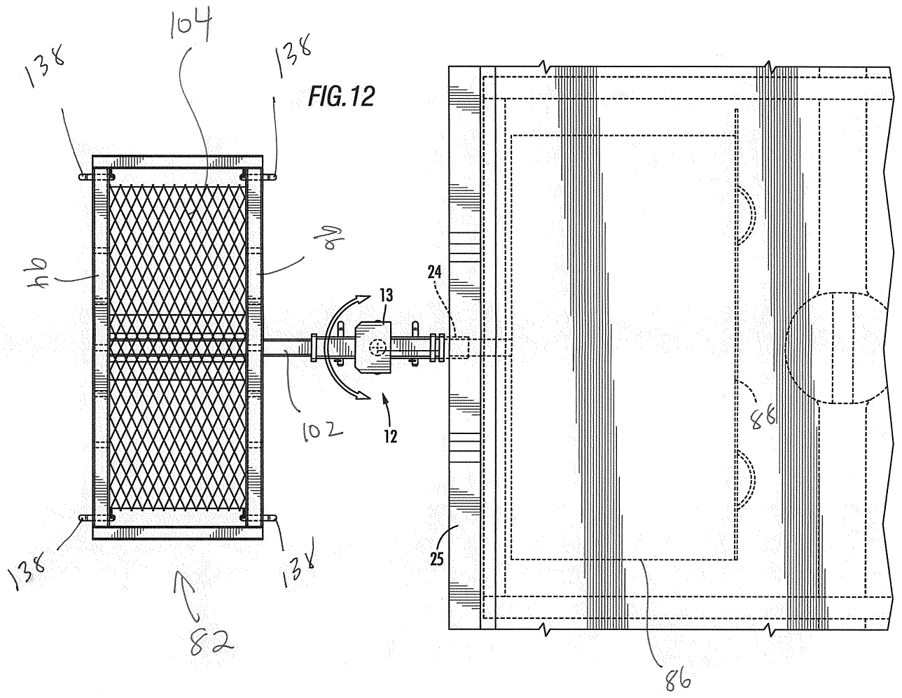

The left slidable tray 106 may be adapted for locking engagement with the main central section 83 at one or more locking positions as desired. In a specific embodiment, the forward support beam 94 may include one or more sets of aligned transverse apertures 134, and the rear support beam 96 may likewise include one or more sets of aligned transverse apertures 136. The forward support beam 120 and the rear support beam 122 on the left slidable tray 106 may include corresponding sets of aligned transverse apertures adapted for alignment with the one or more sets of aligned transverse apertures 134/136 in the forward and rear support beams 94 and 96 on the main central section 83. When the corresponding sets of transverse sets of apertures are aligned, then a locking pin 138 can be passed therethrough and held in place with a cotter pin 140 to secure the left slidable tray 106 in a desired position relative to the main central section 83, such as its extended position as shown for example in FIG. 13B, or its closed position as shown for example in FIG. 12.

The structure and operation of the right slidable tray 108 is the same as explained above for the left slidable tray 106, as is the manner in which it is slidably engaged with the right side of the main central section 83.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims below. Accordingly, the inventions are therefore to be limited only by the scope of the appended claims. None of the claim language should be interpreted pursuant to 35 U.S.C. 112 (f) unless the word “means” is recited in any of the claim language, and then only with respect to any recited “means” limitation.

1. A tool box attachment for engagement with a vehicle hitch receptacle comprising:
a housing having a rear support member adapted for releasable engagement with the vehicle hitch receptacle; and
a slidable tray slidably mounted within an interior compartment of the housing and moveable between an open position and a closed position, the slidable tray including a locking tab adapted for locking engagement with a locking tab on the housing to secure the slidable tray in its closed position.

2. The tool box attachment of claim 1, further including a support assembly having an upper elongated support member, a lower elongated support member, and a vertical support member, the upper and lower elongated support members being spaced apart from one another, the lower elongated support member having a first socket opening at a first end of the lower elongated support member and a second socket opening at a second end of the lower elongated support member, the lower elongated support member being adapted for rotatable movement relative to the vertical support member and the upper elongated support member, the rear support member being engaged with one of the first and second socket openings, the tool box attachment being moveable from a first position beneath the rear of a vehicle and a second position behind the rear of the vehicle.

3. A tray attachment for engagement with a vehicle hitch receptable comprising:
a main central portion having a forward support beam, a rear support beam, and a central support beam, the forward and rear support beams being spaced apart from and in generally parallel relationship to each other, the central support beam being attached to the forward and rear support beams in generally perpendicular relationship thereto, the central support beam being releasably engageable with the vehicle hitch receptacle;
a left slidable tray having a left support beam, a forward support beam and a rear support beam, the forward support beam on the left slidable tray being slidably engaged with the forward support beam on the main central section, the rear support beam on the left slidable tray being slidably engaged with the rear support beam on the main central section, the left slidable tray being moveable between a closed position and an extended position relative to the main central section; and
a right slidable tray having a right support beam, a forward support beam and a rear support beam, the forward support beam on the right slidable tray being slidably engaged with the forward support beam on the main central section, the rear support beam on the right slidable tray being slidably engaged with the rear support beam on the main central section, the right slidable tray being moveable between a closed position and an extended position relative to the main central section.

4. The tray attachment of claim 3, wherein the main central section further includes a metal mesh floor, the left slidable tray includes a metal mesh floor, and the right slidable tray includes a metal mesh floor.

5. The tray attachment of claim 3, wherein:
the main central section includes a first guide rail on a right end of the rear support beam of the main central section, a second guide rail on a left end of the rear support beam of the main central section, a third guide rail on a right end of the forward support beam of the main central section, and a fourth guide rail on a left end of the forward support beam of the main central section;
the left slidable tray includes a rear guide rail attached to the rear support beam of the left slidable tray, and a forward guide rail attached to the forward support beam of the left slidable tray, the rear guide rail being slidably engaged with the second guide rail on the main central section, and the forward guide rail being slidably engaged with the fourth guide rail on the main central section; and
the right slidable tray includes a rear guide rail attached to the rear support beam of the right slidable tray, and a forward guide rail attached to the forward support beam of the right slidable tray, the rear guide rail being slidably engaged with the first guide rail on the main central section, and the forward guide rail being slidably engaged with the third guide rail on the main central section.

6. The tray attachment of claim 5, wherein the first and second guide rails are attached to a lower surface of the rear support beam of the main central section, and the third and fourth guide rails are attached to a lower surface of the forward support beam of the main central section.

7. The tray attachment of claim 5, wherein the first, second, third and fourth guide rails are formed from angle iron, the rear and forward guide rails on the left slidable tray are formed from angle iron, and the rear and forward guide rails on the right slidable tray are formed from angle iron.

8. The tray attachment of claim 7, wherein a planar section of the first guide rail is slidably engaged with a planar section of the rear guide rail of the right slidable tray, a planar section of the third guide rail is slidably engaged with a planar section of the forward guide rail on the right slidable tray, a planar section of the second guide rail is slidably engaged with a planar section of the rear guide rail on the left slidable tray, and a planar section of the fourth guide rail is slidably engaged with a planar section of the forward guide rail on the left slidable tray.

9. The tray attachment of claim 5, wherein the first guide rail defines a first guide channel between the first guide rail and the rear support beam, the second guide rail defines a second guide channel between the second guide rail and the rear support beam, the third guide rail defines a third guide channel between the third guide rail and the forward support beam, and the fourth guide rails defines a fourth guide channel between the fourth guide rail and the forward support beam.

10. The tray attachment of claim 5, wherein:
the rear guide rail on the left slidable tray defines a rear guide channel between the rear support beam on the left slidable tray and the rear guide rail on the left slidable tray, and the forward guide rail on the left slidable tray defines a forward guide channel between the forward support beam on the left slidable tray and the forward guide rail on the left slidable tray; and
the rear guide rail on the right slidable tray defines a rear guide channel between the rear support beam on the right slidable tray and the rear guide rail on the right slidable tray, and the forward guide rail on the right slidable tray defines a forward guide channel between the forward support beam on the right slidable tray and the forward guide rail on the right slidable tray.

11. The tray attachment of claim 5, further including:
a right support plate connected between a right end of the rear guide rail of the left slidable tray and a right end of the forward guide rail of the left slidable tray; and
a left support plate connected between a left end of the rear guide rail of the right slidable tray and a left end of the forward guide rail on the right slidable tray.

12. The tray attachment of claim 3, further including a support assembly having an upper elongated support member, a lower elongated support member, and a vertical support member, the upper and lower elongated support members being spaced apart from one another, the lower elongated support member having a first socket opening at a first end of the lower elongated support member and a second socket opening at a second end of the lower elongated support member, the lower elongated support member being adapted for rotatable movement relative to the vertical support member and the upper elongated support member, the central support beam of the main central section being engaged with one of the first and second socket openings, the tray attachment being moveable from a first position beneath the rear of a vehicle and a second position behind the rear of the vehicle.

13. A tray attachment for engagement with a vehicle hitch receptable comprising:
a main central portion having a forward support beam, a rear support beam, and a central support beam, the forward and rear support beams being spaced apart from and in generally parallel relationship to each other, the central support beam being attached to the forward and rear support beams in generally perpendicular relationship thereto, the central support beam being releasably engageable with the vehicle hitch receptacle;
the main central section further including a first guide rail on a right end of the rear support beam of the main central section, a second guide rail on a left end of the rear support beam of the main central section, a third guide rail on a right end of the forward support beam of the main central section, and a fourth guide rail on a left end of the forward support beam of the main central section;
a left slidable tray having a left support beam, a forward support beam and a rear support beam, the forward support beam on the left slidable tray being slidably engaged with the forward support beam on the main central section, the rear support beam on the left slidable tray being slidably engaged with the rear support beam on the main central section, the left slidable tray being moveable between a closed position and an extended position relative to the main central section;
the left slidable tray further including a rear guide rail attached to the rear support beam of the left slidable tray, and a forward guide rail attached to the forward support beam of the left slidable tray, the rear guide rail being slidably engaged with the second guide rail on the main central section, and the forward guide rail being slidably engaged with the fourth guide rail on the main central section;
a right slidable tray having a right support beam, a forward support beam and a rear support beam, the forward support beam on the right slidable tray being slidably engaged with the forward support beam on the main central section, the rear support beam on the right slidable tray being slidably engaged with the rear support beam on the main central section, the right slidable tray being moveable between a closed position and an extended position relative to the main central section; and
the right slidable tray further including a rear guide rail attached to the rear support beam of the right slidable tray, and a forward guide rail attached to the forward support beam of the right slidable tray, the rear guide rail being slidably engaged with the first guide rail on the main central section, and the forward guide rail being slidably engaged with the third guide rail on the main central section.

14. The tray attachment of claim 13, wherein the main central section further includes a metal mesh floor, the left slidable tray includes a metal mesh floor, and the right slidable tray includes a metal mesh floor.

15. The tray attachment of claim 13, wherein the first and second guide rails are attached to a lower surface of the rear support beam of the main central section, and the third and fourth guide rails are attached to a lower surface of the forward support beam of the main central section.

16. The tray attachment of claim 13, wherein the first, second, third and fourth guide rails are formed from angle iron, the rear and forward guide rails on the left slidable tray are formed from angle iron, and the rear and forward guide rails on the right slidable tray are formed from angle iron.

17. The tray attachment of claim 16, wherein a planar section of the first guide rail is slidably engaged with a planar section of the rear guide rail of the right slidable tray, a planar section of the third guide rail is slidably engaged with a planar section of the forward guide rail on the right slidable tray, a planar section of the second guide rail is slidably engaged with a planar section of the rear guide rail on the left slidable tray, and a planar section of the fourth guide rail is slidably engaged with a planar section of the forward guide rail on the left slidable tray.

18. The tray attachment of claim 13, wherein the first guide rail defines a first guide channel between the first guide rail and the rear support beam, the second guide rail defines a second guide channel between the second guide rail and the rear support beam, the third guide rail defines a third guide channel between the third guide rail and the forward support beam, and the fourth guide rails defines a fourth guide channel between the fourth guide rail and the forward support beam.

19. The tray attachment of claim 13, wherein:
the rear guide rail on the left slidable tray defines a rear guide channel between the rear support beam on the left slidable tray and the rear guide rail on the left slidable tray, and the forward guide rail on the left slidable tray defines a forward guide channel between the forward support beam on the left slidable tray and the forward guide rail on the left slidable tray; and
the rear guide rail on the right slidable tray defines a rear guide channel between the rear support beam on the right slidable tray and the rear guide rail on the right slidable tray, and the forward guide rail on the right slidable tray defines a forward guide channel between the forward support beam on the right slidable tray and the forward guide rail on the right slidable tray.

20. The tray attachment of claim 13, further including:
a right support plate connected between a right end of the rear guide rail of the left slidable tray and a right end of the forward guide rail of the left slidable tray; and
a left support plate connected between a left end of the rear guide rail of the right slidable tray and a left end of the forward guide rail on the right slidable tray.
